(19) United States
(12) Patent Application Publication
(10) Pub. No.: US 2025/0358155 A1
(43) Pub. Date: Nov. 20, 2025

(54) SYSTEMS AND METHODS FOR IMPULSIVE NOISE DETECTION AND MITIGATION

(71) Applicant: HFCL Limited, Bangalore (IN)

(72) Inventors: Sonali Sonali, Bangalore (IN); Subhas Chandra Mondal, Bangalore (IN)

(21) Appl. No.: 19/212,926

(22) Filed: May 20, 2025

(30) Foreign Application Priority Data
May 20, 2024 (IN) 202441039407

(51) Int. Cl. H04L 25/03; H04L 5/00; H04L 25/02

(52) U.S. Cl. CPC H04L 25/03299; H04L 5/0007; H04L 25/0212

(57) ABSTRACT

Systems (100) and methods (200) for impulsive noise detection and mitigation are described. In particular, the system (100) includes a transmitter (102), a communication channel (106), and a receiver (104). The transmitter (102) is configured to encode an input signal, modulate the encoded signal for transmission through the communication channel (106), and transform the modulated signal into a time-domain signal. The communication channel (106) is configured to transmit the time-domain signal and a control signal from the transmitter (102) to a receiver (104). The receiver (104) is configured to transform the time-domain signal into a frequency-domain signal, detect a position of impulsive noise in the frequency-domain signal based at least on identifying a position of null subcarriers in the frequency-domain signal via the control signal, and initiate the suppression of the impulsive noise from the frequency-domain signal.

### CROSS REFERENCE TO RELATED APPLICATIONS

The present application claims the benefit of Indian Patent Application number 202441039407 filed on May 20, 2024, the contents of which are incorporated herein by reference in their entirety.

### TECHNICAL FIELD

The present disclosure, in general, relates to noise detection and mitigation in a wireless communication network, and in particular, relates to systems and methods for impulsive noise detection and mitigation for an Orthogonal Frequency Division Multiplexing (OFDM) signal.

### BACKGROUND

Impulsive noise has become a prevalent and rapidly expanding source of disruptive interference in various applications, including cellular communications, vehicular communications, power line communication, underwater acoustic communication, and the Internet of Things. The disruptive noise can originate from diverse sources such as motors, highly efficient lighting, and even other wireless systems like pulse-type or frequency-modulated continuous wave radars. Impulsive interference has the potential to significantly deteriorate signal quality, leading to reception failures and an increase in bit errors, ultimately compromising the reliability of the entire system.

Orthogonal Frequency Division Multiplexing (OFDM) technology has been widely adopted in most modern wireless communication standards. In conventional OFDM receivers, the time-domain received signal is converted into the frequency-domain through Discrete Fourier transform (DFT), after which each subcarrier is demodulated independently. Such tone-by-tone demodulation achieves optimal maximum likelihood detection in Additive White Gaussian Noise (AWGN) and perfect channel state information. When the impulsive noise is present, the corresponding frequency-domain noise samples may be highly dependent and tone-by-tone demodulation is no longer feasible since the complexity of performing joint-detection at the receiver increases exponentially with the number of subcarriers. Efficient impulsive noise suppression method plays an important role in promoting the performance of OFDM communication systems in the presence of additive impulsive noise. While OFDM inherently exhibits greater resistance to impulsive noise compared to single-carrier modulation, the system's performance can still deteriorate when the power of impulsive noise exceeds a certain threshold and its impact spreads across all subcarriers. Conventionally, impulsive noise degrades the signal-to-noise ratio and deteriorates the performance of the system.

The existing systems do not offer any intelligent mechanism to suppress the effects of impulsive noise. Few existing systems require large number of zero subcarriers comparable to data subcarriers in order to achieve better results. However, increasing the number of zero subcarriers decreases the overall throughout of the system. The existing systems fail to mitigate the impact of impulsive noise adequately to ensure that there is a minimal degradation in system performance.

Therefore, there is a need for a system and a method for mitigating the disruptive impact of impulsive noise. In particular, there is a need for a system and a method for effective impulsive noise detection and mitigation technique which does not add latency, and removes or suppresses the effect of impulsive noise.

### OBJECTS OF THE PRESENT DISCLOSURE

It is an object of the present disclosure to provide a system and a method for impulsive noise detection and mitigation.

It is an object of the present disclosure to provide a system and a method to enhance system performance.

It is an object of the present disclosure to maintain effective throughput of the system in the presence of impulsive noise.

### SUMMARY

In an aspect, the present disclosure relates to a method for impulsive noise detection and suppression, including detecting, by a processor, a position of impulsive noise in a frequency-domain signal based at least on identifying a position of null subcarriers in the frequency-domain signal, and initiating, by the processor, the suppression of the impulsive noise from the frequency-domain signal.

In an embodiment, detecting, by the processor, the position of the impulsive noise may include for each of a plurality of positions in the frequency-domain signal, selecting, by the processor, a given position of the plurality of positions for the impulsive noise in the frequency-domain signal, predicting, by the processor, a value of the impulse noise based on the position of the null subcarriers, updating, by the processor, a received vector corresponding to the frequency-domain signal by removing the impulse noise, and determining, by the processor, an estimated noise energy value of the updated received vector for the given position in the frequency-domain signal.

In an embodiment, the method may include determining, by the processor, the given position in the frequency-domain signal having a minimum estimated noise energy value, and identifying, by the processor, the given position in the frequency-domain signal as the position of the impulsive noise.

In an embodiment, the position of the null subcarriers may be identified via a control signal.

In an embodiment, the method may include suppressing, by the processor, the impulsive noise by subtracting, by the processor, additional magnitude value from the received vector caused by the value of the impulsive noise at the detected position of the impulsive noise.

In another aspect, the present disclosure relates to a wireless communication system for impulsive noise detection and suppression, including a transmitter configured to encode an input signal, modulate the encoded signal for transmission through a communication channel, and transform the modulated signal into a time-domain signal, the communication channel configured to transmit the time-domain signal and a control signal from the transmitter to a receiver, and the receiver configured to receive the time-domain signal and the control signal from the transmitter via the communication channel, transform the time-domain signal into a frequency-domain signal, detect a position of impulsive noise in the frequency-domain signal based at least on identifying a position of null subcarriers in the frequency-domain signal via the control signal, and initiate the suppression of the impulsive noise from the frequency-domain signal.

In an embodiment, the receiver may be configured to detect the position of the impulsive noise by being configured to for each of a plurality of positions in the frequency-domain signal, select a given position of the plurality of positions for the impulsive noise in the frequency-domain signal, predict a value of the impulse noise based on the position of the null subcarriers, update a received vector corresponding to the frequency-domain signal by removing the impulse noise, and determine an estimated noise energy value of the updated received vector for the given position for the impulsive noise in the frequency-domain signal.

In an embodiment, the receiver may be configured to determine the given position in the frequency-domain signal having a minimum estimated noise energy value, and identify the given position in the frequency-domain signal as the position of the impulsive noise.

In an embodiment, the receiver may be configured to suppress the impulsive noise from the determined position of the impulsive noise in the frequency-domain signal by subtracting additional magnitude value from the received vector caused by the value of the impulsive noise.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example representation of the proposed system, in accordance with an embodiment of the present disclosure.

FIG. 2 illustrates a flow diagram of an example method for impulsive noise detection and mitigation, in accordance with an embodiment of the present disclosure.

FIGS. 3 and 4 illustrate example graphical representations of Symbol Error Rate (SER) of proposed system and conventional system.

FIG. 5 illustrates an example computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Impulsive noise may be broadly categorized into two types: asynchronous and periodic. Asynchronous impulsive noise is generated mainly from the switching transients of electrical appliances. It is characterized by brief yet powerful impulses with random occurrence patterns. Periodic impulsive noise often originates from switching mode power supplies. It manifests as longer bursts of interference spikes that occur at regular intervals, typically aligning with half the main cycle of the power grid.

In various wireless communication contexts, such as vehicular networks, smart grids, and shallow sea underwater networks, the quality of data transmission may be significantly deteriorated by impulsive noise. The origins of impulsive noise are multifaceted, ranging from ignition noise in vehicles to switches in electrical equipment and various maritime activities. Unlike Additive White Gaussian Noise (AWGN), impulsive noise occurs sporadically, characterized by short-lived bursts of high-power impulses. Orthogonal Frequency Division Multiplexing (OFDM) is less sensitive to impulsive noise than single carrier by spreading the effect of impulsive noise across all subcarriers. Further, for a certain threshold, the impulsive noise may lead to loss of many adjacent subcarriers leading to poor error performance of the system.

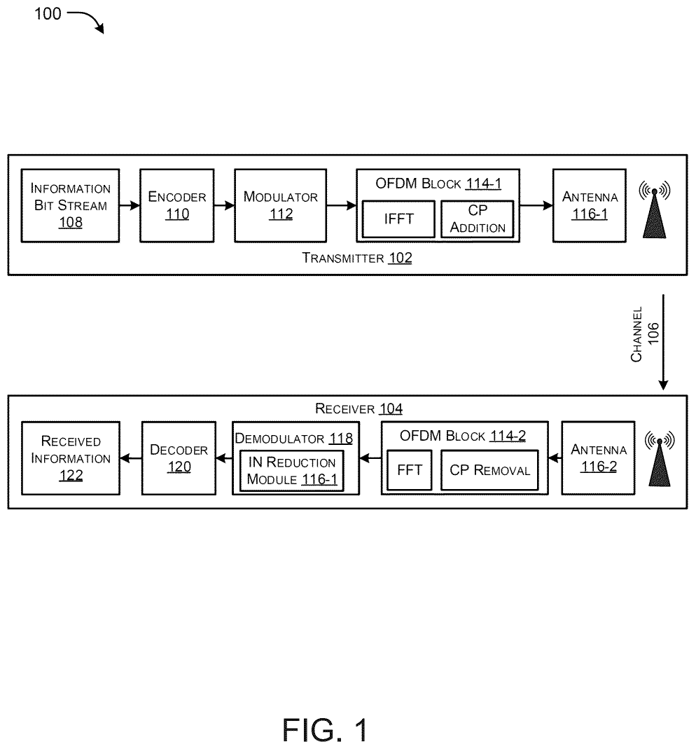

To address the limitations of the conventional systems, a channel coding-driven approach is discussed herein for mitigating impulsive noise in an OFDM-based communication system. The various embodiments throughout the disclosure will be explained in more detail with reference to FIGS. 1-5.

FIG. 1 illustrates an example architecture of a system (100), in accordance with an embodiment of the present disclosure.

In particular, the system (100) includes a transmitter (102) and a receiver (104). In some embodiments, the present disclosure utilizes null subcarriers along with their known positions at the receiver (104) to detect and suppress impulsive noise within the system (100).

Referring to FIG. 1, information bit stream (108) may refer to a sequence of binary digits conveying data or commands, crucial in modern communication systems for transmitting and processing information efficiently and reliably. The information bit stream (108) is the backbone of digital communication, originating from diverse sources and undergoing encoding, modulation, and error correction for effective transmission. An encoder (110) may refer to a device or mechanism that converts information from one format or representation to another, essential for translating data into a suitable form for transmission or storage in various communication and computing systems. In some example embodiments, the encoder (110) may include Low-Density Parity-Check (LDPC) codes, Polar codes, but not limited to the like.

A modulator (112) may refer to a component or process that alters properties of a carrier signal, such as its amplitude, frequency, or phase, to encode information onto it for transmission through a communication channel (106), crucial in various communication systems like radio, television, and digital communication. In an example embodiment, encoded symbols are mapped to M-ary Quadrature Amplitude Modulation (QAM).

In some embodiments, the transmitter (102) may include an OFDM block (114-1). The OFDM block (114-1) performs inverse Fast Fourier transform (iFFT) and cyclic prefix (CP) addition operations. The modulated data bits are transmitted through the OFDM block (114-1) to obtain the time-domain symbols. Further, the transmitter (102) includes a transmitting antenna (116-1). An antenna may refer to a transducer device that converts electrical signals into electromagnetic waves (transmitting antenna (116-1)) or vice versa (receiving antenna (116-2)), enabling wireless communication by transmitting and receiving radio frequency signals in various applications such as radio broadcasting, wireless-fidelity (Wi-Fi), and cellular networks.

The channel (106) may refer to the medium through which information is transmitted from the transmitter (102) to the receiver (104). The channel (106) may include physical mediums like cables or wireless transmission through the air. The characteristics of the channel (106), such as bandwidth, noise, and distortion, influence the quality and reliability of the transmitted information.

Referring to FIG. 1, the receiver (104) may include a receiving antenna (116-2). The antenna (116-2) may refer to a device that captures electromagnetic waves from the air and converts them into electrical signals for processing by electronic devices such as radios, televisions, or wireless communication receivers. The receiving antenna (116-2) picks up signals transmitted by the transmitting antenna (116-1) and delivers them to the receiving equipment for further processing. The receiving antenna (116-2) captures the transmitted symbols perturbed by the channel effects. In some embodiments, the receiver (104) receives the signal together with WGN and impulsive noise.

In some embodiments, the receiver (104) includes an OFDM block (114-2) that performs cyclic prefix (CP) removal and FFT operations. In some embodiments, the received information is then de-mapped to M-ary QAM by a demodulator (118). In some embodiments, the effect of impulsive noise may be removed by an impulsive noise (IN) reduction module (118-1) utilizing the fact that null sub-carriers are already present in 5G new radio (NR)-based communication.

Referring to FIG. 1, a decoder (120) may refer to a device or mechanism that reverses the process of encoding, converting encoded data back into its original format or representation. It is essential for extracting information from received signals in communication systems, enabling interpretation and utilization of transmitted data by the intended recipient. Further, received information (122) denotes the data or signals received by the receiver (104) after transmission through the channel (106), subject to processing for message extraction.

In accordance with embodiments of the present disclosure, the transmitter (102) may encode an input signal via the encoder (110). The encoded signal may be modulated by the modulator (112) for transmission through the channel (106). The modulated signal may be transformed into a time-domain signal by the OFDM block (114-1). In some embodiments, the channel (106) may transmit the time-domain signal and a control signal from the transmitter (102) to the receiver (104). The receiver (104) may receive the time-domain signal and the control signal from the transmitter (102) via the channel (106). The time-domain signal may be transformed into a frequency-domain signal by the OFDM block (114-2).

A position of impulsive noise in the frequency-domain signal may be detected by the IN reduction module (118-1) at the demodulator (118). In some embodiments, the position of impulsive noise may be detected based on, but not limited to, identifying a position of null subcarriers in the frequency-domain signal via the control signal. In some embodiments, for each of a plurality of positions in the frequency-domain signal, a given position may be selected for the impulsive noise. A value of the impulsive noise may be predicted based on the position of the null subcarriers. A received vector corresponding to the frequency-domain signal may be updated by removing the impulsive noise, and an estimated noise energy value of the updated received vector for the given position for the impulsive noise may be determined. In some embodiments, a position may be determined in the frequency-domain signal having a minimum estimated noise energy value. This position in the frequency-domain signal may be identified as the position of the impulsive noise.

Suppression of the impulsive noise from the frequency-domain signal may be initiated by the IN reduction module (118-1). In some embodiments, the impulsive noise from the determined position may be suppressed by subtracting additional magnitude value from the received vector caused by the value of the impulsive noise. This will be explained in detail hereafter.

In an example embodiments, a sequence of data bits may be input into the transmitter (102). The transmitter (102) includes the application of channel encoding to the source bits, the conversion of coded bits into modulated symbols, and the addition of pilot symbols. The modulated symbols Xₖ, k=0, 1, . . . , N−1, may represent an OFDM symbol. Following this, the modulated symbols undergo conversion into the time-domain through an N-point IFFT. Subsequently, the transmit vector in time-domain may be represented as x=[x₀, x₁, . . . , x_{N}]^{T}. In some embodiments, the received signal may be affected by both AWGN represented as n=[n₀, n₁, . . . , n_{N}]^{T}, and impulsive noise denoted as i=[0 . . . nᵢ . . . 0]^{H}, where N is the total number of subcarriers. The frequency-domain samples may be converted to the time-domain OFDM samples and may be represented as follows:

$${x}_{m} = \frac{1}{\sqrt{N}} {\sum }_{k = 0}^{N - 1} {X}_{k} {e}^{( \frac{j 2 π km}{N} )}$$

where m denotes the subcarriers which m=0, 1, . . . , N−1 and Xₖ is the QAM modulated data. When IFFT operation is denoted in terms of IFFT matrix, the time-domain mapped output samples may be as follows:

$$x = WX$$

where W denotes IFFT matrix. The information may be subsequently directed to a cyclic prefix module, which introduces redundancy into the data flow to mitigate inter-symbol interference. Upon reaching the receiver (104), the cyclic prefix is eliminated, and the data is processed through the FFT module. The FFT output may be formulated as follows:

$${X}_{k} = \frac{1}{\sqrt{N}} {\sum }_{m = 0}^{N - 1} {x}_{m} {e}^{( \frac{- j 2 π km}{N} )}$$

FFT operation in matrix format,

$$X = {W}^{H} x$$

where W^{H} gives Hermitian transpose of W. After the received information passes through OFDM block (114-2) at the receiver (104), the symbols become Y=FFT(x+n+i)=FFT(IFFT(X)+n+i).

Considering an example of four samples of the modulated symbol, denoted as x₁, x₂ x₃, and x₄ are transmitted, with x₃, and x₄ representing known samples (null sub-carriers). The location of the null-subcarriers may be identified by the control signal, as existing in 5G NR.

Following transmission through the channel (106), addition of noise and after FFT operation, frequency domain version of the transmitted information is received as follows:

$$[ \begin{matrix}{Y}_{1} \\ {Y}_{2} \\ {Y}_{3} \\ {Y}_{4}\end{matrix} ] = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] [ \begin{matrix}{x}_{1} \\ {x}_{2} \\ {x}_{3} \\ {x}_{4}\end{matrix} ] + [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] [ \begin{matrix}{n}_{1} \\ {n}_{2} \\ {n}_{3} \\ {n}_{4}\end{matrix} ] + [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] [ \begin{matrix}{i}_{1} \\ {i}_{2} \\ {i}_{3} \\ {i}_{4}\end{matrix} ]$$

where a₁₁ to a₄₄ are FFT matrix coefficients and Y₁ to Y₄ represent received information (in frequency domain), n₁, n₂, n₃ and n₄ and i₁, i₂, i₃ and i₄ denote AWGN and impulsive noise values.

If the above equation is solved, at known positions where null values were sent, then the below is received:

$$[ \begin{matrix}{Y}_{3} \\ {Y}_{4}\end{matrix} ] = [ \begin{matrix}{a}_{31} & {a}_{32} & {a}_{33} & {a}_{34} \\ {a}_{41} & {a}_{42} & {a}_{43} & {a}_{44}\end{matrix} ] [ \begin{matrix}{x}_{1} \\ {x}_{2} \\ 0 \\ 0\end{matrix} ] + [ \begin{matrix}{a}_{31} & {a}_{32} & {a}_{33} & {a}_{34} \\ {a}_{41} & {a}_{42} & {a}_{43} & {a}_{44}\end{matrix} ] [ \begin{matrix}{n}_{3} \\ {n}_{4}\end{matrix} ] [ \begin{matrix}{n}_{1} \\ {n}_{2} \\ {n}_{3} \\ {n}_{4}\end{matrix} ] + [ \begin{matrix}{a}_{31} & {a}_{32} & {a}_{33} & {a}_{34} \\ {a}_{41} & {a}_{42} & {a}_{43} & {a}_{44}\end{matrix} ] [ \begin{matrix}{i}_{1} \\ {i}_{2} \\ {i}_{3} \\ {i}_{4}\end{matrix} ]$$

Assuming AWGN noise to be zero for simplicity because amplitude of WGN is very less as compared to impulsive noise in time domain, then ln=IFFT⁻¹(Y). This helps in predicting impulsive noise, which can be removed from Y. It is recognized that ln is an impulsive noise and thus, it may be a very sparse vector. In some embodiments, the impulsive noise may be present only at one place in n×1 vector as, [0 . . . nᵢ . . . 0]^{H}.

Following to the time-domain sparsity of impulsive noise, it may be assumed in an example embodiment that impulsive noise is added only at one location in IFFT data. Thus, a procedure of assuming impulsive noise at each symbol location one by one and decoding its correct location using the information of known null subcarriers is discussed herein. If it is known that x₃ and x₄ were sent as zero samples, leading to certainty of Y₃ and Y₄ being as zero, the above matrix format is opened in equation format as:

$${Y}_{1} = {a}_{11} ( {x}_{1} + {i}_{1} ) + {a}_{12} {x}_{2} + {a}_{13} {x}_{3} + {a}_{14} {x}_{4} ,$$

$${Y}_{2} = {a}_{21} ( {x}_{1} + {i}_{1} ) + {a}_{22} {x}_{2} + {a}_{23} {x}_{3} + {a}_{24} {x}_{4}$$

$${Y}_{3} = {a}_{31} ( {x}_{1} + {i}_{1} ) + {a}_{32} {x}_{2} + {a}_{33} {x}_{3} + {a}_{34} {x}_{4} = 0$$

$${Y}_{4} = {a}_{41} ( {x}_{1} + {i}_{1} ) + {a}_{42} {x}_{2} + {a}_{43} {x}_{3} + {a}_{44} {x}_{4} = 0$$

where it is assumed that impulsive noise is not present at other samples, i.e., i₂, i₃ and i₄=0. After this step, it is obvious that at the receiver Y₃ and Y₄ will not be equal to zero due to the noise components and known variables in equation. Hence, minimum mean square error (MMSE) estimation may be used to calculate i₁. Then, i₁ is removed from the original received information.

Next, this process is repeated for impulsive noise at other locations. For example,

$${Y}_{3} = {a}_{31} {x}_{1} + {a}_{32} ( {x}_{2} + {i}_{2} ) + {a}_{33} {x}_{3} + {a}_{34} {x}_{4} = 0$$

$${Y}_{4} = {a}_{41} {x}_{1} + {a}_{42} ( {x}_{2} + {i}_{2} ) + {a}_{43} {x}_{3} + {a}_{44} {x}_{4} = 0$$

In some embodiments, during this process, impulsive noise in i₁, i₃, and i₄ is considered to be zero, except at the second location. Using the above two equations, Y may be determined, and its effects may be removed to find the estimated noise energy of the received symbols. This step is repeated for i₃ and i₁.

It may be noted that impulsive noise may be added in only one column of the IFFT matrix. If it is assumed that column to be x₃ symbol, and thus x₃×nᵢ=y^{Z}. Then, computation logic may be used to find the value of nᵢ using the known equations.

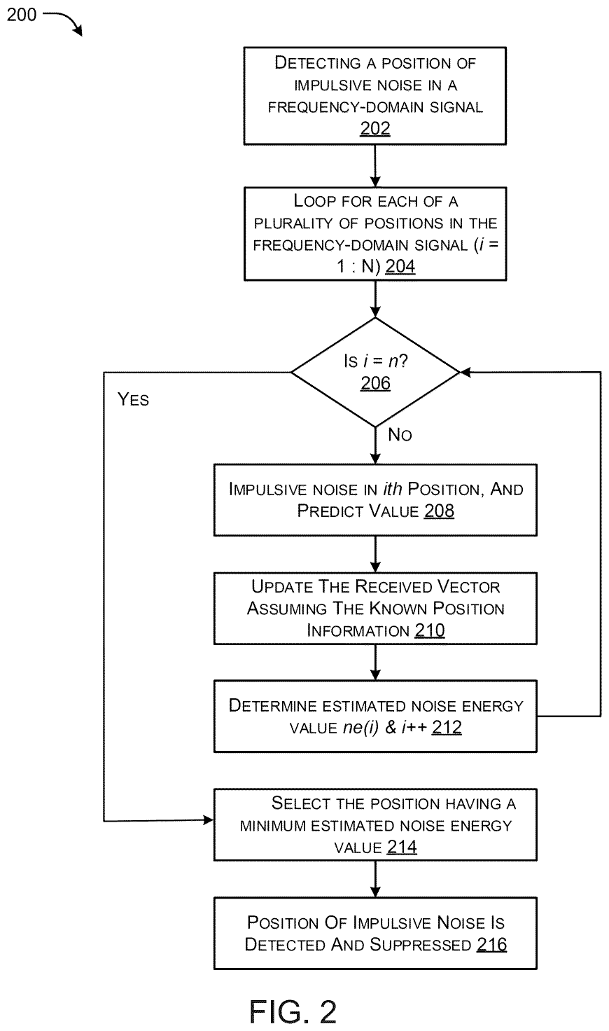

FIG. 2 shows a flow chart of an example method (200) for impulsive noise detection and mitigation, in accordance with an embodiment of the present disclosure.

In accordance with embodiments of the present disclosure, the method (200), at block 202, includes detecting a position of impulsive noise in a frequency-domain signal based on identifying a position of null subcarriers in the frequency-domain signal, and initiating the suppression of the impulsive noise from the frequency-domain signal.

Referring to FIG. 2, at block 204, a loop for a plurality of positions in a frequency-domain signal is initiated. At block 206, the method (200) includes determining if i=n, where n is the number of transmitted bits. In some embodiments, at block 208, if i is not equal to n, the method (200) includes selecting a given position as having impulsive noise in the frequency-domain signal, i.e. assuming that noise is present in the ith position, and predicting the value of the impulsive noise based on the position of the null subcarriers.

At block 210, received vector corresponding to a frequency-domain signal is updated by using the known position information, i.e. known position information of null subcarriers and removing the impulsive noise. At block 212, estimated noise energy (ne) value of the updated received vector may be determined, and the value of i is moved to the next value. The method (200) incudes iterating i from 1 to n. In some embodiments, the position of the null subcarriers may be identified via the control signal.

In some embodiments, if at block 206, i is equal to n, the method (200) proceeds to block 214. At block 214, the method (200) includes determining the position of impulsive noise for which minimum estimated noise energy value is obtained, for example, after the estimation and removal of the impulsive noise effect), leveraging the property that log-likelihood ratio (LLR) approaches infinity in the absence of noise in the system (100). Consequently, by eliminating the noise effect from the correct position, the LLR is always maximized. It may be appreciated that a specific length Lₑₙ is considered for impulsive noise, which is optimized using a stochastic gradient algorithm with an objective function to minimize noise energy (ne).

Assuming N symbols in each block, and after performing FFT, each symbol corresponds to an M-QAM symbol with added noise. To estimate the noise energy in the received samples, after performing FFT of the received vector, QAM samples with noise will be obtained. The noise energy may be predicted as

$${\sum }_{i} {( {r}_{i} - {q}_{i , p} )}^{2} ,$$

where rᵢ is the received sample and qᵢ is the predicted QAM symbol. For calculating the noise energy, the square distance is calculated, where distance is the minimum distance between the received number and the QAM sample values. To calculate distance, the two closest real numbers may be identified from the M-QAM grid, denoted as ‘a’ and ‘b’, to which each real number of the QAM symbol may map. Then, the distance of the real number from these two numbers may be measured, referred to as ‘dₐ’ and ‘d_{b}’.

Referring to FIG. 2, at block 216, the position of impulsive noise is detected and the impulsive noise is suppressed.

In some embodiments, the suppression of noise is done using the known variables to find the unknowns. The value of impulsive noise is estimated using the known samples. The received samples (time-domain) are updated after removing the effect of impulsive noise. The noise energy is estimated for every received sample after FFT operation. The sample with the minimum estimated noise energy is selected to identify the position and magnitude of the impulsive noise. After identifying the position and the magnitude of the impulsive noise, the effect of the impulsive noise is suppressed by subtracting the additional magnitude signal from the received sample or vector caused by the impulsive noise at the identified position. The modified samples (after removal of the impulsive noise) are further processed (FFT operation, guard band removal, demodulation, etc.) to decode and identify the original information. By leveraging the effect of noise energy, the length of impulsive noise may also be identified.

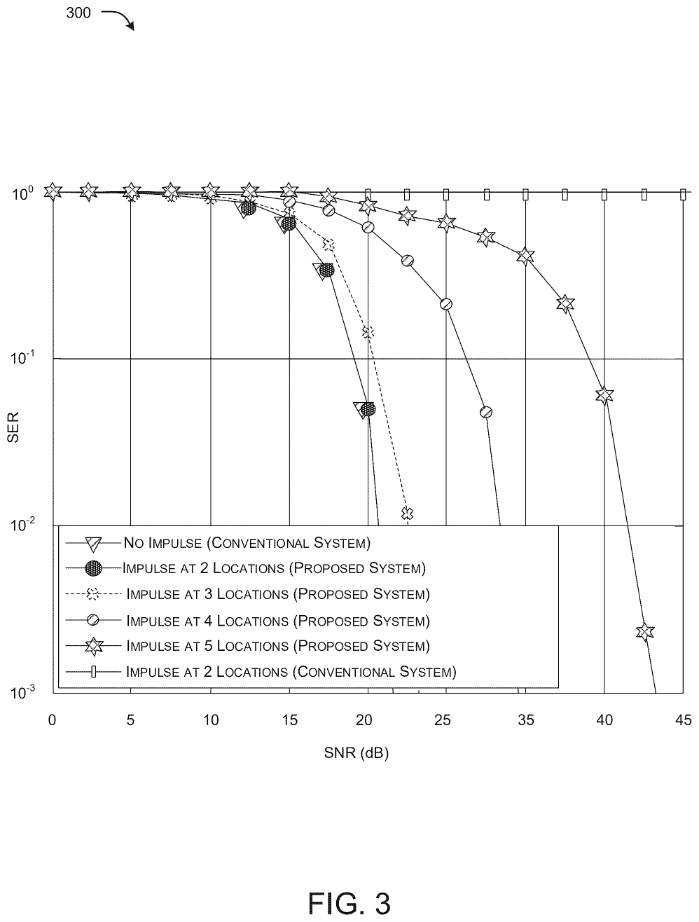

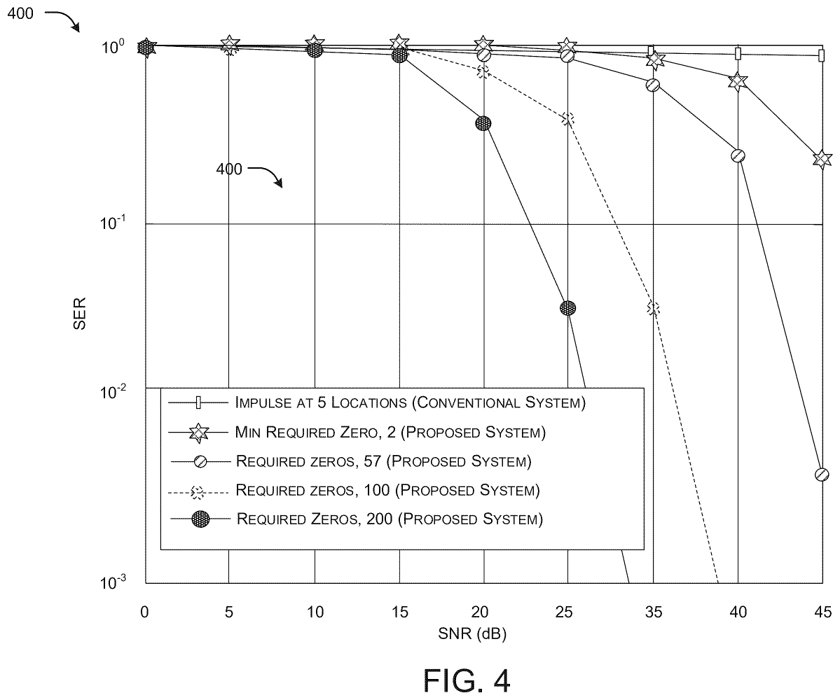

FIGS. 3 and 4 show example graphical representations (300, 400) of symbol error rate (SER) plots of the proposed system (100) and the conventional system.

In an example embodiment, the impact of impulsive noise on system performance measurements is considered, with the Bernoulli-Gaussian model utilized as an example for analyzing the performance of the proposed system (100). It may be appreciated that other impulsive noise models, such as the Middleton Class A model, Gaussian mixture model, and the like may also be used for analyzing the performance within the scope of the present disclosure. Impulsive noise is generated using both Bernoulli and Gaussian random variables. The Bernoulli random variable, with a mean of p, indicates that noise is present in only p percentage of samples.

In FIG. 3, the comparison between the conventional and proposed systems for various positions of impulsive noise detected at the receiver side is shown. The plot shows that as the number of locations with detected impulsive noise increases, the SER performance deteriorates. However, when examining the conventional system, specifically the case where impulsive noise is present at two locations without any decoding algorithm to estimate or suppress it, almost the entire OFDM symbol is affected by errors. Additionally, FIG. 3 includes the scenario where no impulsive noise is present, demonstrating that the proposed system (100) matches this performance even when impulsive noise is present at two locations. When the conventional schemes can achieve 10⁻⁴ BER under normal environment, it is observed that the BER performance significantly deteriorates when employing OFDM in the presence of impulsive noise. Note that, the results for TM3.1 data modulated with 64-QAM is plotted and in the presence of AWGN and impulsive noise.

In FIG. 4, the scenario where the receiver detects impulsive noise at five locations in the received information, is shown. The proposed solution employs a variable number of null subcarriers to decode the information. The plot demonstrates that as the number of null subcarrier locations increases, the SER performance improves. Notably, the effects of impulsive noise are considered in all cases. Furthermore, utilizing more null subcarriers consistently results in a zero SER. When impulsive noise is detected at two locations, only two null subcarriers is required to decode the information correctly.

Additionally, the SER plots remain unchanged regardless of the magnitude of the impulsive noise. Even with the highest magnitude of impulsive noise considered, the information is decoded correctly without any additional requirements. It may be appreciated that SER is proportional to BER, and accordingly, the BER of the system may also reduce by implementing the proposed solution.

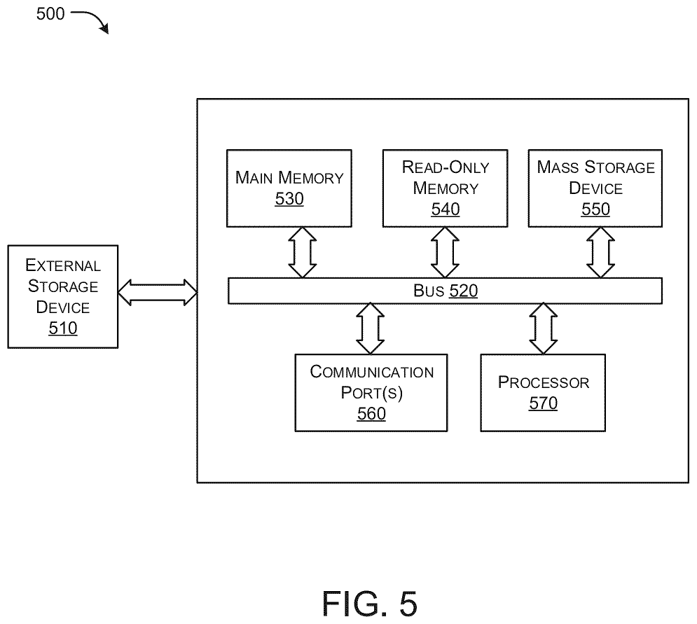

FIG. 5 illustrates an example computer system (500) in which or with which embodiments of the present disclosure may be implemented. It may be appreciated that the system (100) or any block of the system (100) may be implemented as the computer system (500). In some embodiments, the IN reduction module (118-1) may be implemented as the computer system (500). For example, the IN reduction module (118-1) may include a processor and a memory comprising processor-executable instructions to perform the methods discussed herein.

The blocks of the flow diagram shown in FIG. 2 has been arranged in a generally sequential manner for ease of explanation; however, it is to be understood that this arrangement is merely exemplary, and it should be recognized that the processing associated with method (200) may occur in a different order (for example, where at least some of the processing associated with the blocks is performed in parallel and/or in an event-driven manner). Further, it may be appreciated that the steps shown in FIG. 2 are merely illustrative. Other suitable steps may be used for the same, if desired. Moreover, the steps of the method (300) may be performed in any order and may include additional steps.

The methods and techniques described herein may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 5, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 5 illustrates an exemplary computer system (500) in which or with which embodiments of the present disclosure may be utilized. The computer system (500) may be implemented as or within the system (100) described in accordance with embodiments of the present disclosure.

As depicted in FIG. 5, the computer system (500) may include an external storage device (510), a bus (520), a main memory (530), a read-only memory (540), a mass storage device (550), communication port(s) (560), and a processor (570). A person skilled in the art will appreciate that the computer system (500) may include more than one processor (570) and communication ports (560). The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (560) may be chosen depending on a network, such a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chips for storing static information e.g., start-up or basic input output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) communicatively couples the processor (570) with the other memory, storage, and communication blocks. The bus (520) may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and a cursor control device, may also be coupled to the bus (520) to support direct operator interaction with the computer system (500). Other operator and administrative interfaces may be provided through network connections connected through the communication port(s) (560). Components described above are meant only to exemplify various possibilities. In no way should the aforementioned exemplary computer system (500) limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure provides a system and a method thereof for impulsive noise detection and mitigation.

The present disclosure facilitates identification of position of impulsive noise without adding additional complexity in the system.

The present disclosure provides enhanced system performance.

The present disclosure provides that the throughput of the system does not entirely go down even when the impulsive noise occurs periodically in the system.

I/We claim:

1. A method for impulsive noise detection and suppression, comprising:
detecting (202), by a processor (570), a position of impulsive noise in a frequency-domain signal based at least on identifying a position of null subcarriers in the frequency-domain signal; and
initiating, by the processor (570), the suppression of the impulsive noise from the frequency-domain signal.

2. The method as claimed in claim 1, wherein detecting, by the processor (570), the position of the impulsive noise comprises:
for each of a plurality of positions in the frequency-domain signal:
selecting (208), by the processor (570), a given position of the plurality of positions for the impulsive noise in the frequency-domain signal;
predicting (208), by the processor (570), a value of the impulse noise based on the position of the null subcarriers;
updating (210), by the processor (570), a received vector corresponding to the frequency-domain signal by removing the impulse noise; and
determining (212), by the processor (570), an estimated noise energy value of the updated received vector for the given position in the frequency-domain signal.

3. The method as claimed in claim 2, comprising:
determining (214), by the processor (570), the given position in the frequency-domain signal having a minimum estimated noise energy value; and
identifying (216), by the processor (570), the given position in the frequency-domain signal as the position of the impulsive noise.

4. The method as claimed in claim 1, wherein the position of the null subcarriers is identified via a control signal.

5. The method as claimed in claim 3, comprising suppressing (216), by the processor (570), the impulsive noise by:
subtracting, by the processor (570), additional magnitude value from the received vector caused by the value of the impulsive noise at the detected position of the impulsive noise.

6. A wireless communication system (100) for impulsive noise detection and suppression, comprising:
a transmitter (102) configured to:
encode an input signal;
modulate the encoded signal for transmission through a communication channel (106); and
transform the modulated signal into a time-domain signal;
the communication channel (106) configured to transmit the time-domain signal and a control signal from the transmitter (102) to a receiver (104); and
the receiver (104) configured to:
receive the time-domain signal and the control signal from the transmitter (102) via the communication channel (106);
transform the time-domain signal into a frequency-domain signal;
detect a position of impulsive noise in the frequency-domain signal based at least on identifying a position of null subcarriers in the frequency-domain signal via the control signal; and
initiate the suppression of the impulsive noise from the frequency-domain signal.

7. The system (100) as claimed in claim 6, wherein the receiver (104) is configured to detect the position of the impulsive noise by being configured to:
for each of a plurality of positions in the frequency-domain signal:
select a given position of the plurality of positions for the impulsive noise in the frequency-domain signal;
predict a value of the impulse noise based on the position of the null subcarriers;
update a received vector corresponding to the frequency-domain signal by removing the impulse noise; and
determine an estimated noise energy value of the updated received vector for the given position for the impulsive noise in the frequency-domain signal.

8. The system (100) as claimed in claim 7, wherein the receiver (104) is configured to:
determine the given position in the frequency-domain signal having a minimum estimated noise energy value; and
identify the given position in the frequency-domain signal as the position of the impulsive noise.

9. The system (100) as claimed in claim 8, wherein the receiver (104) is configured to suppress the impulsive noise from the determined position of the impulsive noise in the frequency-domain signal by subtracting additional magnitude value from the received vector caused by the value of the impulsive noise.
